(19) United States
(12) Patent Application Publication
(10) Pub. No.: US 2011/0074635 A1
(43) Pub. Date: Mar. 31, 2011

(54) METHOD AND APPARATUS FOR POSITIONING

(75) Inventors: Geon Min YEO, Daejeon (KR); Byung-Han RYU, Daejeon (KR); Hyeong Jun PARK, Daejeon (KR); Sook Jin LEE, Daejeon (KR)

(73) Assignee: Electronics and Telecommunications Research Institute., Daejeon (KR)

(21) Appl. No.: 12/895,006

(22) Filed: Sep. 30, 2010

(30) Foreign Application Priority Data
Sep. 30, 2009 (KR) 10-2009-0093228
Sep. 30, 2010 (KR) 10-2010-0095194

(51) Int. Cl. G01S 5/02

(52) U.S. Cl. 342/464

(57) ABSTRACT

Provides are method and apparatus for wireless positioning. An exemplary embodiment of the present invention provides a method for wireless positioning, which includes: receiving signals from a plurality of transmitters; determining propagation delay tabs of the plurality of transmitters, from the signals received from the plurality of transmitters, respectively; setting the order of the plurality of transmitters in accordance with the propagation delay tabs; measuring distances between a receiver and the transmitter, respectively; and estimating the position of the receiver, by using the order and the measured distance.

### CROSS-REFERENCE TO RELATED APPLICATION

This application claims priority to and the benefit of Korean Patent Application No. 10-2009-0093228 and 10-2010-0095194 filed in the Korean Intellectual Property Office on Sep. 30, 2009 and Sep. 30, 2010, the entire contents of which are incorporated herein by reference.

### BACKGROUND OF THE INVENTION

(a) Field of the Invention

The present invention relates to a method and apparatus for positioning. More particularly, the present invention relates to a method and apparatus for wirelessly positioning a terminal on the basis of the types of propagation delay.

(b) Description of the Related Art

Wireless positioning is a technology of positioning a terminal, using a wireless communication system, and this field has been recently increased with the increase of demands for location based service (LBS). Particularly, the wireless positioning technology is increasingly under the spotlight, in accordance with the increase in demand for a technology that can provide users with appropriate service by determining the user's situation and position.

Global positioning system (GPS) that is a representative wireless positioning technology provides positioning results with high accuracy, but has a problem in that a terminal in a room cannot receive a GPS signal and only a terminal equipped with a GPS receiver can receive a GPS signal.

Accordingly, as another wireless positioning technology, an received signal strength indicator (RSSI) method and a time difference of arrival (TDOA) method have been considered. The RSSI method is a method of acquiring positional information, using the intensity of a received signal. According to the RSSI method, the positional information can be easily acquired because the structure is simple, but errors are generated due to path loss.

The TDOA method is a method of acquiring positional information, using a difference in the arrival time of signals. According to the TDOA, time synchronization is not needed between a receiver and a transmitter, but time synchronization is required between the transmitters.

The above-mentioned wireless positioning technology, for example, all of the GPS, RSSI method and TDOA method cannot provide accurate positioning results under a non-line of sight (NLOS) environment or an environment having a bad channel condition. Accordingly, a method that provides an accurate positioning result by reflecting the propagation environment of signals is required.

### SUMMARY OF THE INVENTION

The present invention has been made in an effort to provide a method and apparatus for wireless positioning having advantages of considering the types of propagation delay.

An exemplary embodiment of the present invention provides a method for wireless positioning, which includes: receiving signals from a plurality of transmitters; determining propagation delay tabs of the plurality of transmitters, from the signals received from the plurality of transmitters, respectively; setting the order of the plurality of transmitters in accordance with the propagation delay tabs; measuring distances between a receiver and the transmitter, respectively; and estimating the position of the receiver, by using the order and the measured distance.

Another exemplary embodiment of the present invention provides a method for wireless positioning, which includes: receiving signals from a plurality of transmitters; determining propagation delay tabs of the plurality of transmitters, from the signals received from the plurality of transmitters; setting a reference transmitter in the plurality of transmitters on the basis of the plurality of propagation delay tabs; estimating the position of a receiver by using the distance between a receiver and the reference transmitter; and correcting the position of the receiver by using the distance between the receiver and the other transmitters, except for the reference transmitter, in the plurality of transmitters.

Yet another exemplary embodiment of the present invention provides an apparatus for wireless positioning that includes: a signal receiving unit that receives signals from a plurality of transmitters; a propagation environment determining unit that determines propagation delay tabs of the plurality of transmitters, from the signal received from the plurality of transmitters; a transmitter order setting unit that sets the order of the plurality of transmitters in accordance with the propagation delay tabs; a distance measuring unit that measures the distance between the receiver and each of the transmitters; and a position estimating unit that estimates the position of the receiver by using the order and the measured distances.

### BRIEF DESCRIPTION OF THE DRAWINGS

FIG. 1A to FIG. 1D are diagrams showing a type of propagation delay tab.

FIG. 2 is an apparatus for wireless positioning according to an exemplary embodiment of the present invention.

FIG. 3 is a method of wireless positioning according to an exemplary embodiment of the present invention. The apparatus for wireless positioning may be a part of a receiver.

FIG. 4 to FIG. 6 are diagrams exemplifying a method of estimating the position of a receiver by an apparatus for wireless positioning according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising”, will be understood to imply the inclusion of stated elements but not the exclusion of any other elements.

In the specification, a terminal may designate a mobile station (MS), mobile terminal (MT), a subscriber station (SS), a portable subscriber station (PSS), a user equipment (UE), and an access terminal (AT), etc. and may include the entire or partial functions of the terminal, the mobile station, the mobile terminal, the subscriber station, the portable subscriber station, the user equipment, the access terminal, etc.

In the specification, a base station (BS) may designate a radio access station (RAS), a node B, an evolved node B (eNodeB), a base transceiver station (BTS), and a mobile multihop relay (MMR)-BS, etc. and may include the entire or partial functions of the base station, the radio access station, the node B, the enodeB, the base transceiver station, and the MMR-BS, etc.

Hereinafter, method and apparatus for wireless positioning according to an exemplary embodiment of the present invention will be described in detail with reference to the accompanying drawing.

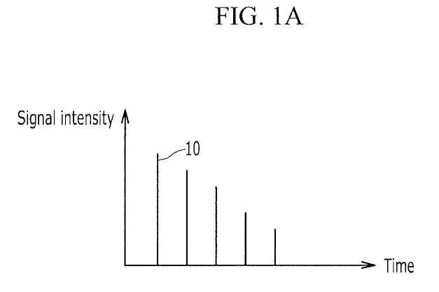

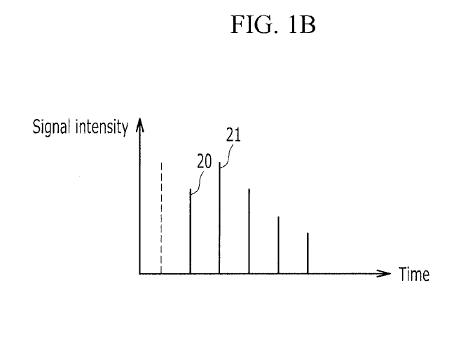

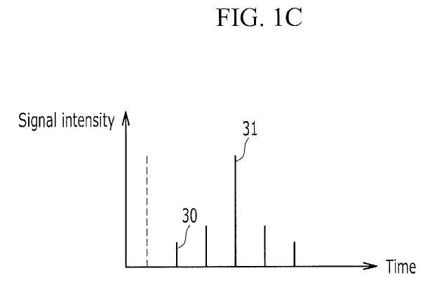

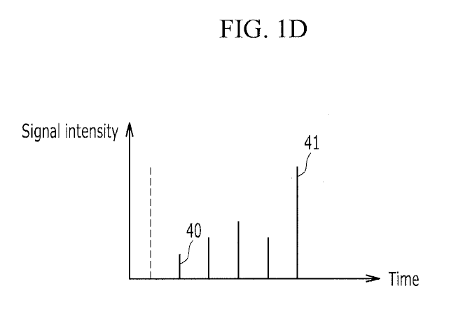

FIG. 1A to FIG. 1D are diagrams showing a type of propagation delay tab.

A propagation delay tab means that a signal transmitted from a transmitter under a multipath environment is a delay spread shape. When a geographical obstacle exists between a transmitter and a receiver, a multipath is formed by reflection or diffraction of a signal due to the obstacle. Therefore, one signal transmitted from the transmitter is delay-spread through the multipath.

Referring to FIG. 1A, the signal intensity of a propagation delay tab 10 which earliest arrives at the receiver is largest. When an geographical obstacle does not exist between the transmitter and the receiver, a signal transmitted from the transmitter can arrive at the receiver, with high signal intensity within a short time. Accordingly, the type of FIG. 1A may be a type of propagation delay under an line of sight (LOS) environment.

Referring to FIG. 1B, the signal intensity of a propagation delay tab 21 which arrives second at the receiver is the largest, and the signal intensity of a propagation delay tabs 20 that arrives first is smaller than the signal intensity of a propagation delay tab 21.

Referring to FIG. 10, the signal intensity of a propagation delay tab 31 which arrives third at the receiver is the largest, and the signal intensity of a propagation delay tabs 30 that arrives first is smaller than the signal intensity of a propagation delay tab 31.

Referring to FIG. 1D, the signal intensity of a propagation delay tab 41 which arrives latest at the receiver is the largest, and the signal intensity of a propagation delay tabs 40 that arrives first is smaller than the signal intensity of a propagation delay tab 41.

As the types of propagation delay tab become similar to the types of FIG. 1A, the environment between the transmitter and the receiver is close to the LOS environment. Further, as the type of propagation delay tabs becomes similar to the types of FIG. 1D, the environment between the transmitter and the receiver is close to the non-line of sight environment.

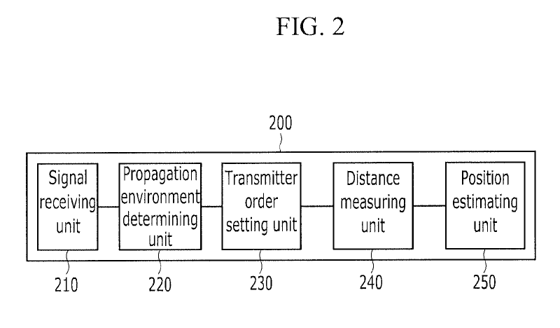

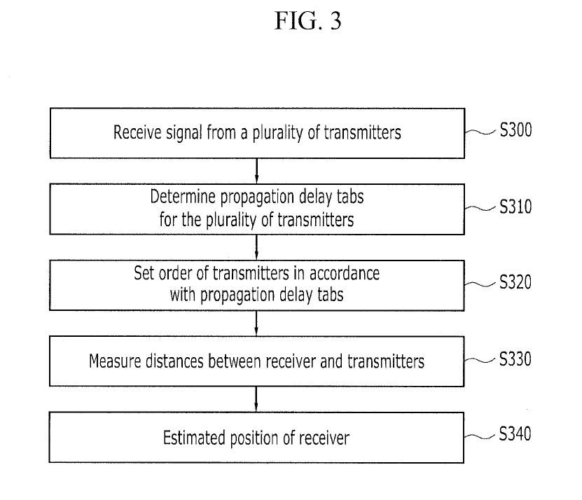

FIG. 2 is a diagram showing an apparatus for wireless positioning according to an exemplary embodiment of the present invention and FIG. 3 is a diagram showing a method for wireless positioning according to an exemplary embodiment of the present invention. The apparatus for wireless positioning may be a part of a receiver. Assume that the apparatus for wireless positioning knows the position of a peripheral transmitter.

Referring to FIG. 2, an apparatus 200 for wireless positioning includes a signal receiving unit 210, a propagation environment determining unit 220, a transmitter order setting unit 230, a distance measuring unit 240, and a position estimating unit 250.

Referring to FIG. 2 and FIG. 3, the signal receiving unit 210 receives signals transmitted from a plurality of transmitters (S300). The signals transmitted from the transmitter, for example, may be reference signals for positioning. Hereinafter, it is exemplified that the signal receiving unit 210 receives reference signals for positioning from the plurality of transmitters, respectively.

The propagation environment determining unit 220 determines propagation delay tabs for the signals transmitted from the plurality of transmitters (S310). In other words, the propagation environment determining unit 220 determines the arrival time of a propagation delay tab having the largest signal intensity in the propagation delay tabs of each of the transmitters. Meanwhile, the propagation environment determining unit 220 can determine the propagation environment on the basis of the propagation delay tabs. For example, when the types of propagation delay tabs for signals transmitted from the transmitters are similar to FIG. 1A, that is, it is determined that the propagation environment between the transmitters and corresponding receivers is the LOS environment, as the signal intensity of the propagation delay tabs arriving first is the largest. As another example, when the type of propagation delay tabs for the signals transmitted from the transmitter are similar to FIG. 1B to FIG. 1D, that is, it is determined that the propagation environment between the transmitters and corresponding receivers is close to the NLOS environment, as the propagation delay tab having the largest signal intensity arrives late.

The transmitter order setting unit 230 sets the order of the transmitters, using the results determined by the propagation environment determining unit 220 (S320). For example, the order may be set as a prior order, as the propagation environment is close to the LOS environment, and the order is set as a latter order, as the propagation environment may be close to the NLOS environment.

The distance measuring unit 240 measures the distances between the transmitters and the receivers (S330). In this case, the distance measuring unit can measures the distance between the transmitter and the receiver, respectively, using the arrival time of the propagation delay tab arriving first in the propagation delay tabs of the transmitters.

The position estimating unit 250 estimates the positions of the receiver, using the order set by the transmitter order setting unit 230 and the distances measured by the distance measuring unit 240 (S340). For example, it is possible to estimate the position of the receiver on the basis of the distance between the prior order transmitter and the receiver and to correct the position of the receiver by using the distance between the latter order transmitter and the receiver.

Hereinafter, a detailed method of estimating the position of a receiver by the apparatus for wireless positioning will be described.

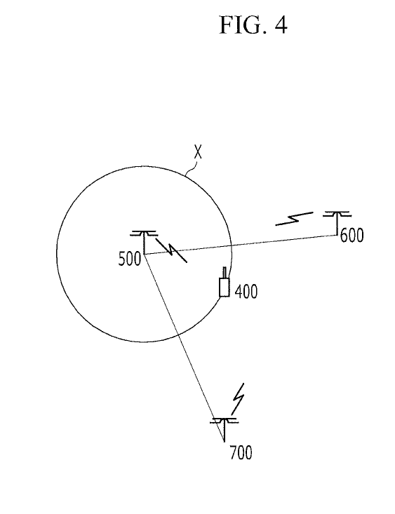

FIG. 4 to FIG. 6 are diagrams exemplifying a method of estimating the position of a receiver by an apparatus for wireless positioning according to an exemplary embodiment of the present invention.

Referring to FIG. 4 to FIG. 6, a receiver 400 that is an object of wireless positioning receives reference signals for positioning from a plurality of transmitters around the receiver, for example, three transmitters 500, 600, and 700. The receiver 400 analyzes the propagation delay tabs for the reference signals received from the transmitters 500, 600, and 700, respectively. Assume that the receiver 400 knows the positions of the transmitters 500, 600, and 700, the arrival time of the propagation delay having the largest signal intensity is the shortest in the transmitter 500, and the arrival time of the propagation delay tabs having the largest signal intensity longest from the transmitter 600 to the transmitter 700. Accordingly, assume that the propagation environment between the receiver 400 and the transmitter 500 is close to the LOS environment, and the propagation environments are closer to the NLOS environment from the transmitter to the transmitter 700.

Referring to FIG. 4, the transmitter 500 having the propagation environment closest to the LOS is a reference transmitter. The receiver 400 measures the distance between the reference transmitter 500 and the receiver 400, using the arrival time and light speed of the propagation delay tab arriving first in the propagation delay tabs of the reference transmitter 500. The receiver 400 determines that the receiver 400 is positioned on a circle spaced apart as much as the calculated distance from the reference transmitter 500 because the propagation environment determined by the propagation delay tab is LOS.

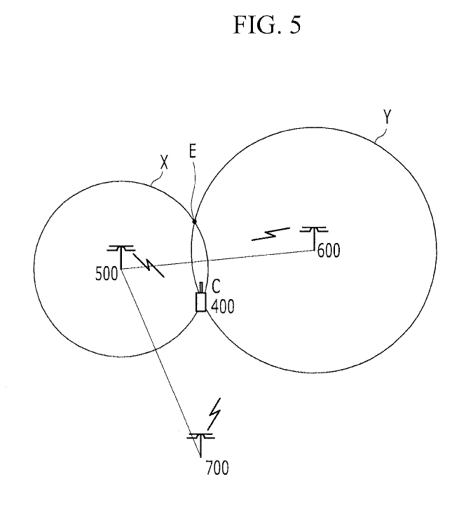

Referring to FIG. 5, the receiver 400 measures the distance between the transmitter 600 having the propagation environment that is close to the LOS environment, next to the reference transmitter 500, and the receiver 400 and forms a circle Y having a center at the transmitter 600. The distance between the transmitter 600 and the receiver 400 can be measured by using the arrival time and light speed of the propagation delay tab arriving the first in the propagation delay tabs of the transmitter 600.

Accordingly, the receiver 400 can determine that the receiver 400 is positioned at an intersection C or an intersection E of the circle Y having a center at the transmitter 600 and the circle X having a center at the transmitter 500.

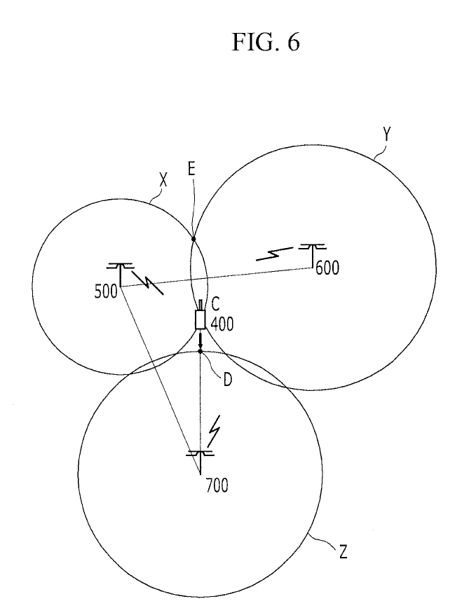

Referring to FIG. 6, the receiver 400 corrects the intersection C calculated through the process descried with reference to FIG. 4 and FIG. 5 in the direction of the transmitter 700. In this case, a start point for a position correction is the intersection C by a circle Z having a center at the transmitter 700. In other words, the receiver 400 can perform the correction that the receiver 400 is positioned at any point D on the straight line connecting the intersection C with the transmitter 700. For example, the receiver 400 calculates the distance between the transmitter 700 having the propagation environments close to the NLOS environment and the receiver 400, and set a circle Z having a center at the transmitter. Further, the position of the receiver 400 can be corrected to the intersection of the straight line connecting the intersection C with the position of the transmitter 700 and a circle Z having a center at the transmitter 700. The correction method is not limited thereto. The distance may be corrected by various methods based on the circle Z. For example, if a radius of the circle Z is large, the distance may be corrected from the intersection E.

In the above, for better comprehension and ease of description, although it is assumed that the receiver receives reference signals for positioning from three transmitters, the scope of the present invention is not limited thereto. The receiver may receive reference signals for positioning from three or more transmitters, and may perform positioning on the basis of the received reference signals according to the propagation environment priority of LOS.

As described above, when the wireless positioning is performed on the basis of types of the propagation delay tabs, an error of wireless positioning generated when the propagation environments are close to the NLOS environment can be reduced.

According to the exemplary embodiments of the present invention, method and apparatus for wireless positioning, considering the types of propagation delay are provided. Accordingly, it is possible to reduce errors in positioning, according to the propagation environment between transmitters and a receiver.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for wireless positioning, comprising:
receiving signals from a plurality of transmitters;
determining propagation delay tabs of the plurality of transmitters, from the signals received from the plurality of transmitters, respectively;
setting the order of the plurality of transmitters in accordance with the propagation delay tabs;
measuring distances between a receiver and the transmitter, respectively; and
estimating the position of the receiver, by using the order and the measured distance.

2. The method of claim 1, wherein:
the transmitted signals are reference signals for wireless positioning.

3. The method of claim 1, wherein:
the setting of the order includes
setting the order of the plurality of transmitters, in accordance with arrival time of a propagation delay tab having the largest signal intensity in the propagation delay tabs of the plurality of transmitters and a LOS propagation delay priority.

4. The method of claim 3, wherein:
the transmitters having shorter arrival time of the propagation delay tab having the largest signal intensity are set to prior orders.

5. The method of claim 1, wherein:
the setting of the order includes:
determining the propagation environment of the plurality of transmitters in accordance with the propagation delay tabs; and
setting the transmitters having the propagation environments closer to line of sight (LOS) environment to prior orders.

6. The method of claim 1, wherein:
the distance between the receiver and each of the transmitter is calculated by using the arrival time of the propagation delay tab arriving first in the propagation delay tabs of each of the transmitters.

7. The method of claim 1, wherein:
the estimating the position includes:
estimating the position of the receiver on the basis of the distance between a prior order transmitter and the receiver; and
correcting the position of the receiver by using the distance between a latter order transmitter and the receiver.

8. A method for wireless positioning, comprising:
receiving signals from a plurality of transmitters;
determining propagation delay tabs of the plurality of transmitters, from the signals received from the plurality of transmitters;
setting a reference transmitter in the plurality of transmitters on the basis of the plurality of propagation delay tabs;
estimating the position of the receiver by using the distance between a receiver and the reference transmitter; and
correcting the position of the receiver by using the distance between the receiver and the other transmitters, except for the reference transmitter in the plurality of transmitters.

9. The method of claim 8, further comprising:
calculating the distance between the receiver and each of the transmitters, by using arrival time of the propagation delay tab arriving first in the propagation delay tabs of each of the transmitters.

10. The method of claim 8, wherein:
the estimating of position of the receiver includes
estimating that the receiver is positioned on a position constructed by intersections of a circle having a center at the reference transmitter and a radius that is the distance between the receiver and the reference transmitter and a circle having a radius that is a distance between the receiver and a second prior order transmitter.

11. The method of claim 10, wherein:
the correcting of position of the receiver includes
correcting the position of the receiver by using two intersections of a circle having a center at a first transmitter in the other transmitters and a radius that is the distance between the receiver and the first transmitter and a circle having a radius that is the distance between the receiver and a second prior order transmitter.

12. The method of claim 11, wherein:
the correcting of position of the receiver further includes
additionally correcting the position of the receiver to a point where a circle having a center at a second transmitter in the other transmitters and having a radius that is the distance between the receiver and the second transmitter intersects a straight line connecting the intersection with the second transmitter.

13. The method of claim 8, wherein:
the setting a reference transmitter includes
setting a transmitter having the shortest arrival time of the propagation delay tab having the largest signal intensity, as the reference transmitter, in the plurality of transmitters.

14. The method of claim 8, wherein:
the setting of a reference transmitter includes:
determining propagation environments of the plurality of transmitters in accordance with the propagation delay tabs;
setting a transmitter having the propagation environment closest to line of sight (LOS) environment as the reference transmitter.

15. An apparatus for wireless positioning, comprising:
a signal receiving unit that receives signals from a plurality of transmitters;
a propagation environment determining unit that determines propagation delay tabs of the plurality of transmitters, from the signal received from the plurality of transmitters;
a transmitter order setting unit that sets the order of the plurality of transmitters in accordance with the propagation delay tabs;
a distance measuring unit that measures the distance between the receiver and each of the transmitters; and
a position estimating unit that estimates the position of the receiver by using the order and the measured distances.

16. The apparatus of claim 15, wherein:
the transmitter order setting unit sets a transmitter having the shortest arrival time of a propagation delay tab having the largest signal intensity in the plurality of transmitters, as the reference transmitter.

17. The apparatus of claim 16, wherein:
the position estimating unit sets the position of the receiver by using the distance between the receiver and the reference transmitter, and corrects the position of the receiver by using the distances between the receiver and the other transmitters, except for the reference transmitter, in the plurality of transmitters.
